(19) United States
(12) Patent Application Publication
(10) Pub. No.: US 2004/0237314 A1
(43) Pub. Date: Dec. 2, 2004

(54) Pruning hook

(76) Inventor: Chih-Chuan Wu, Taipei (TW)

Correspondence Address: Chih-Chuan Wu, PO Box 82-144, Taipei, TW

(21) Appl. No.: 10/449,101

(22) Filed: Jun. 2, 2003

(51) Int. Cl. B26B 13/00

(52) U.S. Cl. 30/249; 30/246

(57) ABSTRACT

An improved structure of a pruning hook is essentially comprised of a pair of shears substantially similar to the prior art including a drive arm, a hook, and a mobile knife in sequence and a lopping saw provided at the top of an extension rod characterized by that the top of the drive arm being pivoted to an end sleeve at the top of the rod; a restriction chain with a pulley being drawn and inserted to the rod; and the saw being locked to where by the end sleeve to execute pruning with a single hand by hooking the twigs and pulling down the rod to draw the drive arm and the swinging mobile knife.

### BACKGROUND OF THE INVENTION

(a) Field of the Invention

The present invention is related to an improved structure of a pruning hook that can be operated by a single hand to upgrade operation benefits of the pruning hook.

(b) Description of the Prior Art

As an important element in landscaping, trees provide green environment, facilitate lowering ambient temperature and refresh the air. However, periodical pruning is necessary to prevent excessive twigs that may compromise the landscape as a whole, or potential risk of hurting the pedestrian walking under the trees in a storm by twigs broken by the wind. Whereas trees are usually taller than a person, a pruning hook is needed. FIG. 1 of the accompanying drawings shows a structure of a pruning hook generally available in the market; wherein, a rod insertion sleeve (12) is provided to fix it to the top of the extension rod (11). A fixation plate (13) extending upward is provided by the side of the rod insertion sleeve (12), and a fixed pruning knife (131) is formed at the top of the fixation plate (13). A mobile knife (14) adapted to the pruning action executed by the fixed knife (131) is pivoted to the fixation plate (13), and a connection plate (15) is pivoted to the fixed plate (13) and the mobile knife (14) with a pullback coil (16) hooked to where between the free end of the connection plate (15) and the fixed plate (13). A driving pulley (151) is provided to the free end of the connection plate (15), and a protrusion seat (121) is extended in radius from the peripheral of the rod insertion sleeve (12) with a fixed pulley (122) placed on the protrusion seat (121) while another end of a pull cord (17) going around the driving pulley (151) and the fixed pulley in sequence.

Upon pruning, both of the fixed knife (131) and the mobile knife (14) are moved to the pruning position with the pull cord (17) pulled to cause the connection plate (15) to swing down, thus to draw the mobile knife (14) moving toward the side of the fixed knife (131) to swing for cutting off undesired twigs. Meanwhile, the pullback coil (16) is pulled wide open so that when the pull cord (17) is released, both of the connection plate (15) and the mobile knife (14) return to their original positions as pulled by the pullback coil (16).

However, user of the pruning hook finds it difficult to stand firm since he has to use one hand to hold the extension rod and another hand to pull the pull cord. In case of rough twigs are met, the user has to use his both hands to cut off the twigs, the falling twigs and the pruning hook at the same time present risks of hurting people. Furthermore, it is rather troublesome for the user to readjust the length of the pull cord depending on the height of the twigs pending pruning. Therefore, as safety is concerned, improvement of the structure of the prior art is justified.

### SUMMARY OF THE INVENTION

The primary purpose of the present invention is to provide an improved structure of a pruning hook is essentially comprised of a pair of shears substantially similar to the prior art including a drive arm, a hook, and a mobile knife in sequence and a lobbing saw provided at the top of an extension rod. To achieve the purpose, the top of the drive arm is pivoted to an end sleeve at the top of the extension rod, and a restriction chain with a pulley is drawn by and inserted into the rod. The lopping saw is locked to where by the end sleeve to execute pruning with a single hand by hooking the twigs and pulling down the extension rod to draw the drive arm and the swinging mobile knife.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing an assembly of a pruning hook of the prior art.

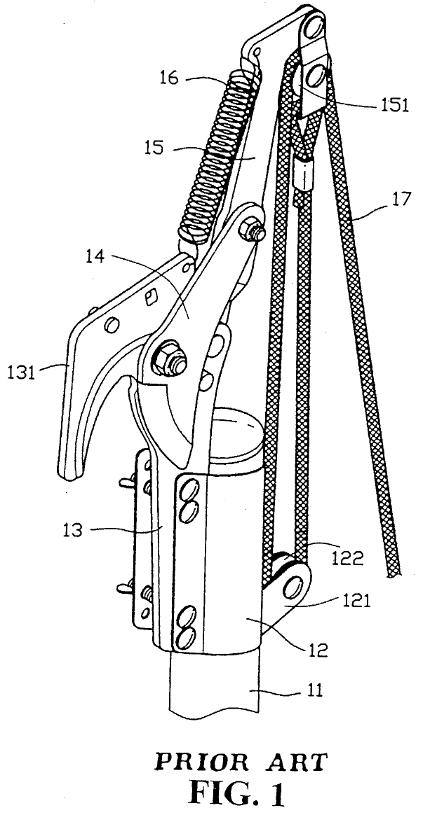

FIG. 2 is a perspective view showing a preferred embodiment of the present invention.

FIG. 3 is a front view showing an assembly of the preferred embodiment of the present invention.

FIG. 4 is a schematic view showing the pruning action of the preferred embodiment of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

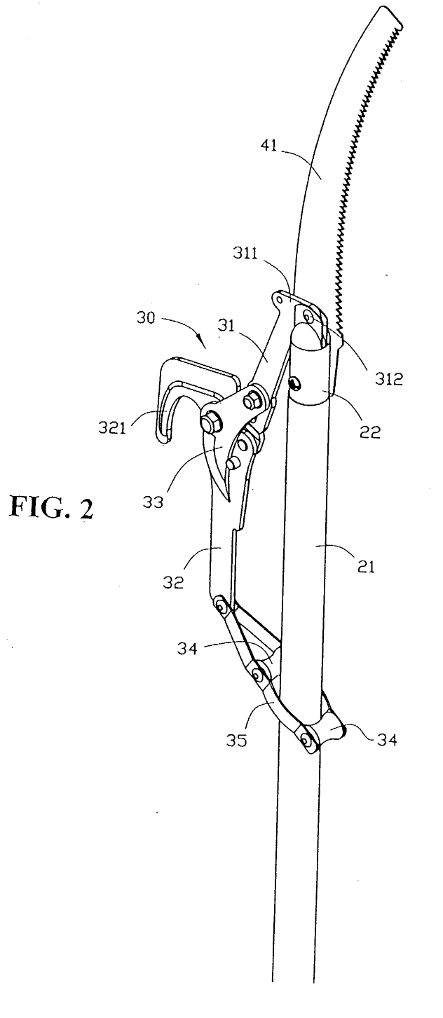

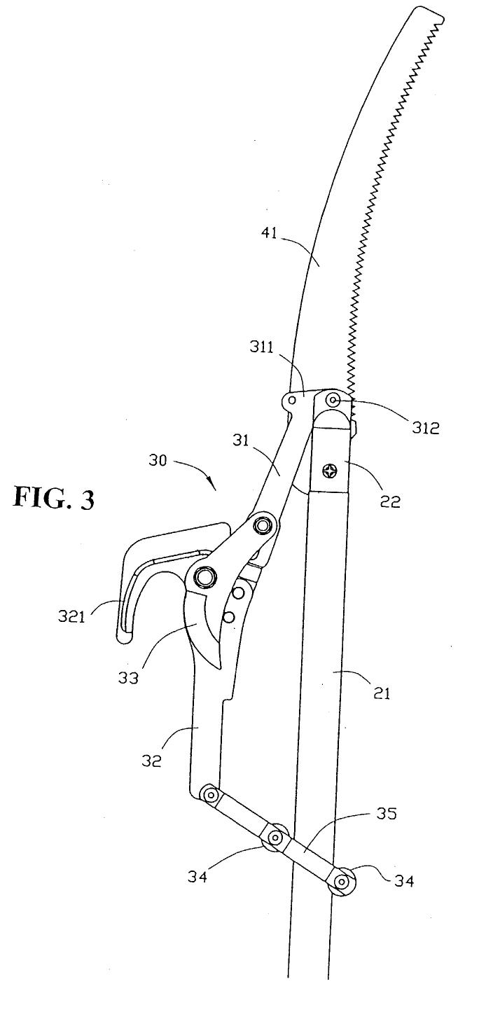

Referring to FIGS. 2 and 3, a preferred embodiment of the present invention for an improved structure of a pruning hook is essentially comprised of a pair of shears (30) and a lopping saw (41) provided at the top of an extension rod (21). Wherein, the pair of shears (30) is comprised of a driving arm (31) with its bottom pivoted to t a hooking plate and its middle section pivoted with a mobile knife (33); the hook plate (32) for the driving arm (31) and the mobile knife (33) to pivot to; and the mobile knife (33) having its middle section axially pivoted to where by the side of a hook (321) of the hook plate (32) and its top pivoted to the middle section of the driving arm (31) in an assembly substantially similar to that of the prior art. To improve the flaw of the prior art that requires the operation of both hands for allowing single hand operation, a shaft bolt (312) is used to pivot the top (311) of the driving arm (31) to an end sleeve (22) provided at the top of the extension rod (21), and the bottom of the hook plate (32) is drawn and inserted into the extension rod (21) with a restriction chain (35) containing a pulley (34) while the lopping saw (41) is locked to where by the end sleeve (22) of the extension rod (21).

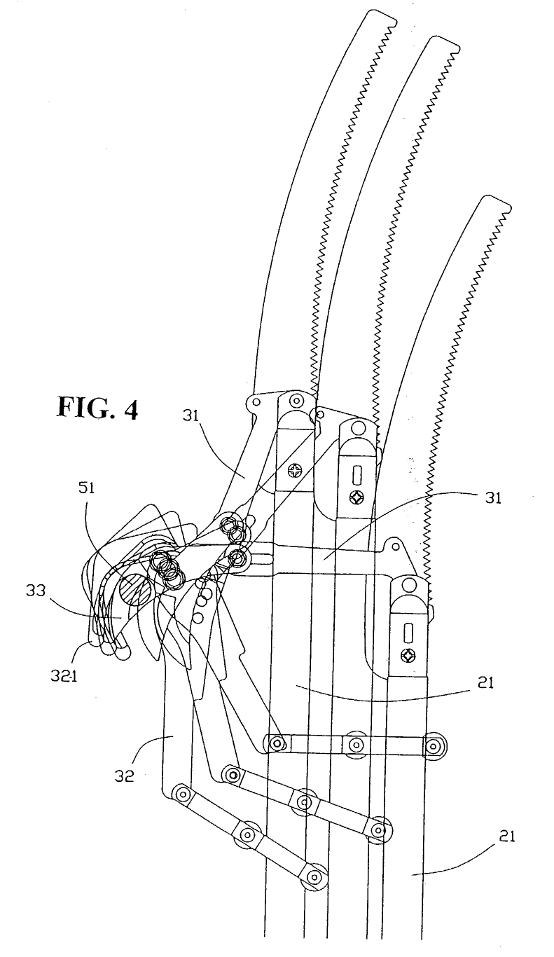

Now referring to FIG. 4, when the hook (321) of the hook plate (32) catches the twigs (51), the extension rod (21) is naturally pulled down to draw in sequence the driving arm (31) and the mobile knife (33) to cut off the twigs (51) by holding the extension with only one hand. In case of rough twigs (51), the extension rod (21) can be also held with both hands to achieve even safer and more stable pruning.

The pair of the shears of the preferred embodiment of the present invention returns downward to its position by its weight to open up the mobile knife (33) in the status as illustrated in FIG. 3.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spit of the present invention.

I claim:

1. A structure of a pruning hook is essentially comprised of a pair of shears substantially similar to the prior art including a drive arm, a hook, and a mobile knife in sequence and a lopping saw provided at the top of an extension rod characterized by that the top of the drive arm being pivoted to an end sleeve at the top of the rod; a restriction chain with a pulley being drawn and inserted to the rod; and the saw being locked to where by the end sleeve to execute pruning with a single hand by hooking the twigs and pulling down the rod to draw the drive arm and the swinging mobile knife.
